(19) United States
(12) Patent Application Publication
(10) Pub. No.: US 2005/0212451 A1
(43) Pub. Date: Sep. 29, 2005

(54) Plasma display panel

(76) Inventor: Jae-Ik Kwon, Suwon-si (KR)

Correspondence Address: MCGUIREWOODS, LLP, 1750 TYSONS BLVD, SUITE 1800, MCLEAN, VA, 22102, US

(21) Appl. No.: 11/082,960

(22) Filed: Mar. 18, 2005

(30) Foreign Application Priority Data
Mar. 25, 2004 (KR) 10-2004-0020286

(51) Int. Cl. G09G 3/10

(52) U.S. Cl. 315/169.4; 315/169.1

(57) ABSTRACT

A plasma display panel comprising a transparent front substrate, a rear substrate disposed parallel to the front substrate, upper partition walls disposed between the front substrate and the rear substrate and demarcating light-emitting cells in a lattice pattern arranged in a first direction, an upper electrode and a lower electrode disposed in the upper partition walls around the light-emitting cells and extending in the first direction, lower partition walls disposed between the upper partition walls and the rear substrate, and an address electrode extending in a direction intersecting the upper electrode and the lower electrode.

### CROSS-REFERENCE TO RELATED APPLICATION

This application claims priority to and the benefit of Korean Patent Application No. 10-2004-0020286, filed on Mar. 25, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP having an improved discharge electrode structure.

2. Discussion of the Background

FIG. 1 and FIG. 2 show a conventional 3-electrode surface discharge PDP 1.

Referring to FIG. 1 and FIG. 2, address electrode lines A₁, A₂, . . . , Aₘ, Y electrode lines Y₁, . . . , Yₙ, X electrode lines X₁, . . . , Xₙ, dielectric layers 102 and 110, phosphor layers 112, partition walls 114, and a protection layer 104 may be disposed between front and rear glass substrates 100 and 106.

The address electrode lines A₁, A₂, . . . , Aₘ may be formed in a predetermined pattern on the rear glass substrate 106, and the lower dielectric layer 110 covers them. The partition walls 114 may be formed parallel to the address electrode lines A₁, A₂, . . . , Aₘ and on the lower dielectric layer 110 to demarcate, and prevent optical interferences between, display cells. The phosphor layers 112 are respectively formed between the partition walls 114.

The X electrode lines X₁, . . . , Xₙ and the Y electrode lines Y₁, . . . , Yₙ may be arranged on the rear surface of the front glass substrate 100, orthogonally to the address electrode lines A₁, A₂, . . . , Aₘ. Each intersection of an X and Y electrode pair with an address electrode forms a corresponding display cell. The X electrode lines X₁, X₂, . . . , Xₙ and the Y electrode lines Y₁, Y₂, . . . , Yₙ may comprise transparent electrodes Xₙₐ and Yₙₐ, which may be formed of a transparent conductive material such as indium tin oxide (ITO), and metal electrodes X_{nb} and Y_{nb}, for increasing conductivity, respectively. The upper dielectric layer 102 covers the X electrode lines and the Y electrode lines, and the protection layer 104 covers the upper dielectric layer 102. The protection layer 104, which protects the PDP 1 from a strong electric field, may be a magnesium oxide (MgO) layer. A discharge space 108 is filled with plasma forming gas and then sealed.

A common driving method for such a PDP includes sequentially performing initialization, addressing, and display-sustain operations in a unit sub-field. The initialization operation uniformly distributes charges in the display cells. The addressing operation sets charge states in the display cells that will, and will not be, selected. The display-sustain operation performs sustain-discharges on selected display cells, thereby generating plasma from plasma forming gas. Ultraviolet rays caused by the plasma excite the display cells' phosphor layers to emit light.

FIG. 3 is a block diagram of a conventional driving apparatus for driving the PDP 1 of FIG. 1.

Referring to FIG. 3, the conventional driving apparatus may include an image processor 300, a logic controller 302, an address driver 306, an X driver 308, and a Y driver 304. The image processor 300 converts an external signal into a digital signal, and generates an internal image signal comprising, for example, R/G/B image data, a clock signal, and horizontal and vertical synchronization signals, each having 8 bits. The logic controller 302 generates driving control signals S_{A}, S_{Y}, and S_{X} in response to the internal image signal received from the image processor 300. The address driver 306 processes the driving control signal S_{A} (also, referred to as an ‘address signal’) to generate a display data signal, and applies the generated display data signal to the address electrode lines. The X driver 308 processes the X driving control signal S_{X} and applies the processed result to the X electrode lines. The Y driver 304 processes the Y driving control signal S_{Y} and applies the processed result to the Y electrode lines.

U.S. Pat. No. 5,541,618 discloses an address-display separation (ADS) driving method that is widely used to drive the PDP 1 described above.

FIG. 4 is a view for explaining a conventional ADS driving method for driving Y electrode lines of the PDP 1 of FIG. 1.

Referring to FIG. 4, a unit frame may be be divided into a predetermined number of sub-fields, for example, 8 sub-fields SF₁, . . . , SF₈, in order to implement time division gray-scale display. Also, each sub-field SF₁, . . . , SF₈ may be divided into reset periods (not shown), address periods A₁, . . . , A₈, and sustain-discharge periods S₁, . . . , S₈, respectively.

During the address periods A₁, . . . , A₈, a display data signal may be applied to the address electrode lines (A₁, A₂, . . . , Aₘ of FIG. 1) while simultaneously and sequentially applying corresponding scan pulses to the respective Y electrode lines Y₁, . . . , Yₙ, to select discharge cells.

During the sustain-discharge periods S₁, . . . , S₈, a display discharge pulse may be alternately applied to the Y electrode lines Y₁, . . . , Yₙ and X electrode lines X₁, . . . , Xₙ to generate a display discharge in the selected discharge cells.

The PDP's brightness is proportional to the number of sustain discharge pulses applied within sustain discharge periods S₁, . . . , S₈ in a unit frame. If a frame forming one image is represented by 8 sub-fields in 256 gray-scales, different numbers (1, 2, 4, 8, 16, 32, 64, and 128) of sustain pulses may be sequentially assigned to the respective sub-fields. In this case, in order to obtain the brightness of a 133 gray-scale level, cells may be addressed and sustain-discharged during the periods of a first sub-field (SF₁), a third sub-field (SF₃), and an eighth sub-field (SF₈).

The number of sustain-discharges (sustain-discharge pulses) assigned to each sub-field may depend on the sub-field's weight based on an automatic power control (APC) driving method. Alternatively, the number of sustain-discharges assigned to each sub-field may be set according to gamma or panel characteristics. For example, it is possible to decrease a gray-scale level assigned to a fourth sub-field (SF₄) from 8 to 6 and increase a gray-scale level assigned to a sixth sub-field (SF₆) from 32 to 34. Also, the number of sub-fields forming one frame may be changed according to a design rule.

FIG. 5 is a timing diagram showing a conventional driving signal for driving the PDP 1 of FIG. 1. FIG. 5 shows driving signals that may be applied to address electrodes A₁ through Aₘ, common electrodes X₁ through Xₙ, and scanning electrodes Y₁ through Yₙ during a sub-field SFₙ according to an ADS driving method. Referring to FIG. 5, a sub-field SFₙ includes a reset period PR, an address period PA, and a sustain-discharge period PS.

During the reset period PR, a reset pulse rising to the level of V_{SET}+V_{S} may be applied to all scanning lines to perform a write discharge on all cells, thereby initializing the states of wall charges in all cells. The reset period PR is performed before the address period PA so that wall charges in all panel cells may be uniformly distributed. During the address period PA, which follows the reset period PR, a bias voltage Vₑ may be applied to the common electrodes X₁ through Xₙ, a scanning pulse V_{SC-L} may be applied to scanning electrodes Y₁ through Yₙ, and a display data signal V_{A} may be applied to address electrodes A1 through Am, thereby selecting cells to be displayed. Unselected scanning electrodes may be biased at V_{SC-H} during the address period. In the sustain-discharge period PS, which follows the address period PA, a sustain pulse V_{S} may be alternately applied to the common electrodes X through Xₙ and the scanning electrodes Y₁ through Yₙ. Further, a low-level voltage V_{G} may be applied to the address electrodes A₁ through Aₘ.

In the 3-electrode surface discharge PDP described above, the X electrodes, the Y electrodes, the dielectric layer 102, and the protection layer 104 are provided on the front substrate 100, and light that forms a visible image passes therethrough. Hence, the front substrate 100 may have a low transmittance of about 60%.

Also, in the conventional 3-electrode surface discharge PDP, since a discharge that is generated only in the upper portion of a display cell spreads to the cell's center portion, its luminous efficiency may be low.

Also, when using such a PDP for a long time, an electric field formed by charged particles in discharge gas may cause ion-sputtering of phosphors, which may burn an image into the PDP.

### SUMMARY OF THE INVENTION

The present invention provides a PDP with an improved structure that may provide an improved opening ratio, transmittance, light-emitting efficiency, and response speed, as well as enable low-voltage driving and prevent ion-sputtering.

Additional features of the invention will be set forth in the description which follows, and in part will be apparent from the description, or may be learned by practice of the invention.

The present invention provides a PDP comprising a transparent front substrate, a rear substrate disposed parallel to the front substrate, upper partition walls disposed between the front substrate and the rear substrate and demarcating light-emitting cells in a lattice pattern arranged in a first direction, an upper electrode and a lower electrode disposed in the upper partition walls around the light-emitting cells and extending in the first direction, lower partition walls disposed between the upper partition walls and the rear substrate, and an address electrode extending in a second direction intersecting the upper electrode and the lower electrode.

The present invention also discloses a light emitting cell of a display panel comprising a first substrate and a second substrate, and a partition wall formed between the first substrate and the second substrate. The partition wall defines a discharge area of the light emitting cell, and a first electrode and a second electrode are in the partition wall.

The present invention also discloses a plasma display apparatus comprising a plasma display panel, an address electrode driver, a first electrode driver, and a second electrode driver. The plasma display panel comprises a first substrate and a second substrate, an upper partition wall formed on a surface of the second substrate facing the first substrate and a lower partition wall formed on a surface of the first substrate facing the second substrate. A light emitting cell is defined by the upper partition wall and the lower partition wall, and the light emitting cell comprises a first electrode and a second electrode in the upper partition wall, and an address electrode formed on the first substrate. During a sustain period, the first electrode driver and the second electrode driver alternately apply a sustain pulse to the first electrode and the second electrode, respectively, and the address electrode driver applies a voltage to the address electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 and FIG. 2 show a conventional 3-electrode surface discharge PDP.

FIG. 3 is a block diagram showing a convention driving apparatus for the PDP of FIG. 1.

FIG. 4 is a view for explaining a conventional address-display separation driving method for driving Y electrode lines of the PDP of FIG. 1.

FIG. 5 is a timing diagram showing conventional driving signals for the PDP of FIG. 1.

FIG. 6, FIG. 7 and FIG. 8 show a PDP according to an exemplary embodiment of the present invention.

FIG. 9A, FIG. 9B, FIG. 9C, FIG. 9D, FIG. 9E and FIG. 9F show a PDP according to an exemplary embodiment of the present invention.

FIG. 10 is a timing diagram showing a sustain-discharge driving signal according to an exemplary embodiment of the present invention.

FIG. 11 is a timing diagram showing a sustain-discharge driving signal according to an exemplary embodiment of the present invention.

FIG. 12 is a view for explaining sustain-discharging of a light-emitting cell by the sustain-discharge signal of FIG. 10.

FIG. 13 is a view for explaining sustain-discharging of a light-emitting cell by the sustain-discharge signal of FIG. 11.

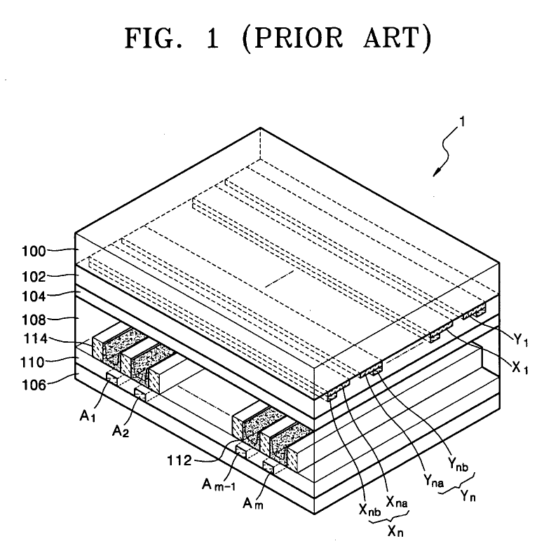

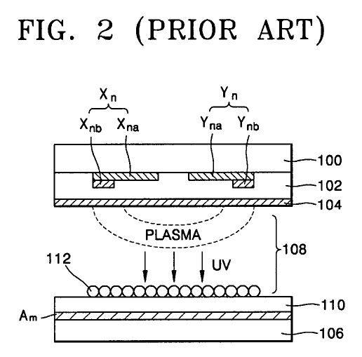

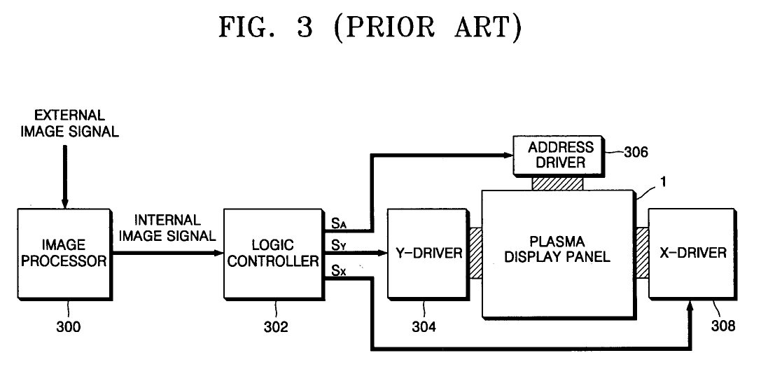

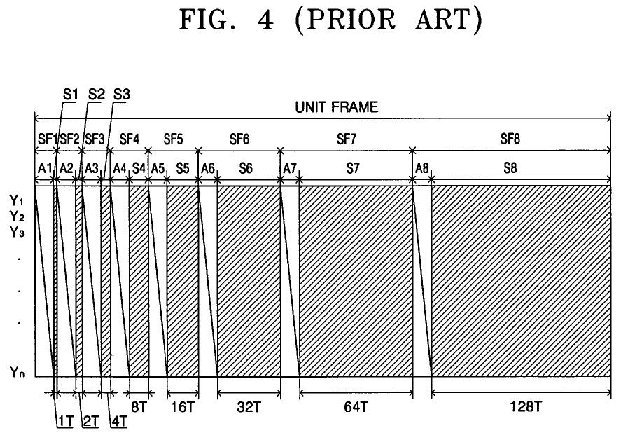

### DETAILED DESCRIPTION OF THE ILLUSTRATED EMBODIMENTS

Hereinafter, a PDP and driving signals thereof, according to exemplary embodiments of the present invention, will be described in detail with reference to the appended drawings.

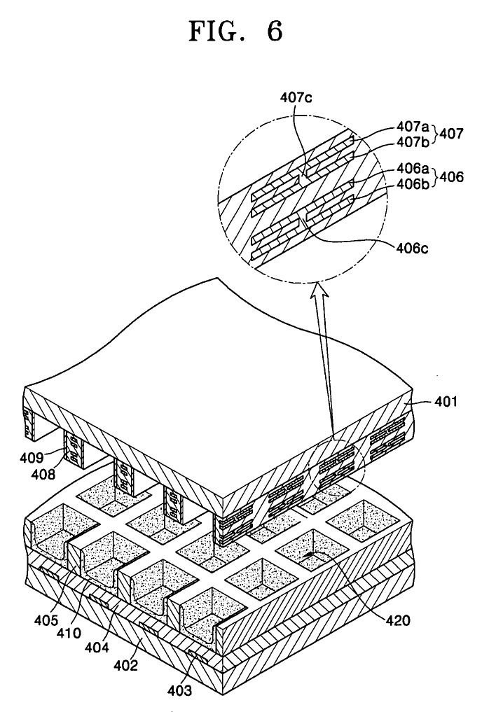

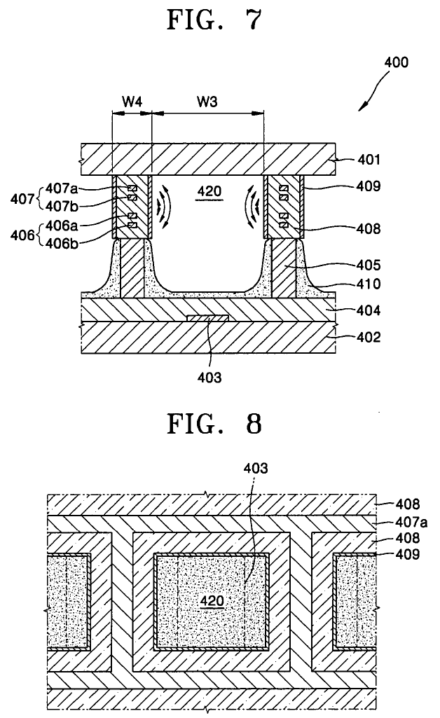

FIG. 6, FIG. 7 and FIG. 8 are views for explaining the structure of a PDP according to an exemplary embodiment of the present invention.

Referring to FIG. 6, FIG. 7 and FIG. 8, the PDP may include a transparent front substrate 401; a rear substrate 402 separated from, and parallel to, the front substrate 401; partition walls 405 and 408 demarcating lattice-type light-emitting cells 420; and upper electrodes 407 (X electrodes) and lower electrodes 406 (Y electrodes) disposed in the partition walls 408 around the light-emitting cells 420. The upper electrodes 407 and the lower electrodes 406 may be arranged along a direction of the lattice-type light-emitting cells 420, for example, in a horizontal direction. Each phosphor layer 410 may cover bottom and lateral portions of each light-emitting cell 420. Each light-emitting cell 420 may be filled with discharge gas (not shown).

Here, the partition walls may comprise upper partition walls 408, formed on the rear surface of the front substrate 401, and lower partition walls 405, formed on the front surface of the rear substrate 402. Alternatively, the upper partition walls 408 and the lower partition walls 405 may be formed as a single partition wall.

When the upper partition walls 408 and the lower partition walls 405 are separately formed, each upper electrode 407 and each lower electrode 406 may be disposed in a upper partition wall 408 around a corresponding light-emitting cell 420, and a phosphor layer 410 may be formed on the bottom surface of the light-emitting cell 420 and the lateral surfaces of the corresponding lower partition wall 405.

Address electrode lines 403 may be formed on the front surface of the rear substrate 402 and in a direction that is orthogonal to the direction in which the lattice-type light-emitting cells 420 are arranged, for example, in a vertical direction. Consequently, the address electrode lines 403 are disposed orthogonal to the upper electrodes 407 and lower electrodes 406.

A dielectric layer 404 may be disposed between the address electrode lines 403 and the phosphor layers 410.

With this structure, using the upper electrodes 407 as common electrodes X and the lower electrodes 406 as scanning electrodes Y may provide more effective address discharging than the reverse situation. In other words, cells may be selected by address discharging through the address electrodes 403 and the lower electrodes 406, and cells may be sustain discharged by alternately applying sustain pulses to the lower electrodes 406 and the upper electrodes 407. Hereinafter describes an embodiment in which each upper electrode 407 is a common electrode X and each lower electrode 406 is a scanning electrode Y.

When the upper partition walls 408 are separate from the lower partition walls 405, dielectric layers forming the upper partition walls 408 may be made of a material that is capable of preventing direct conduction between the Y electrodes 406 and the X electrodes 407 when sustain-discharging, thereby preventing damage to the X and Y electrodes due to the direct collision of charged particles with the electrodes. Such dielectric material may include PbO, B₂O₃, SiO₂, and other like materials.

A protection film 409, such as a MgO film, may cover the lateral surfaces of the upper partition walls 408. The protection film 409 may prevent charged particles from colliding with, and damaging, the upper partition walls 408, and it may accelerate discharging of secondary electrons when discharging.

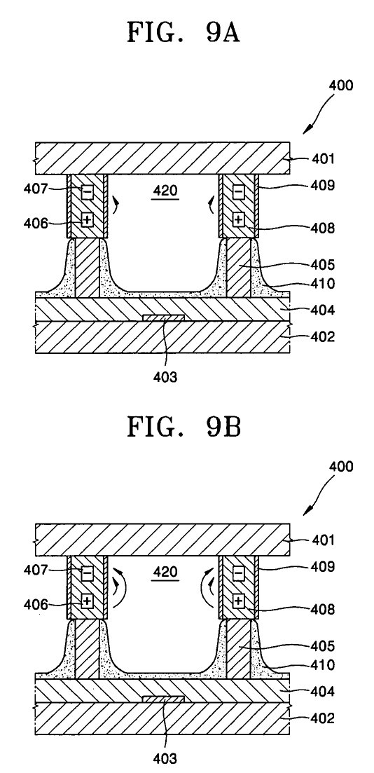

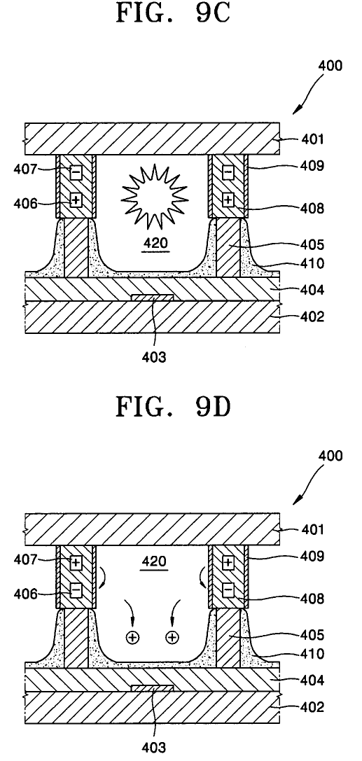

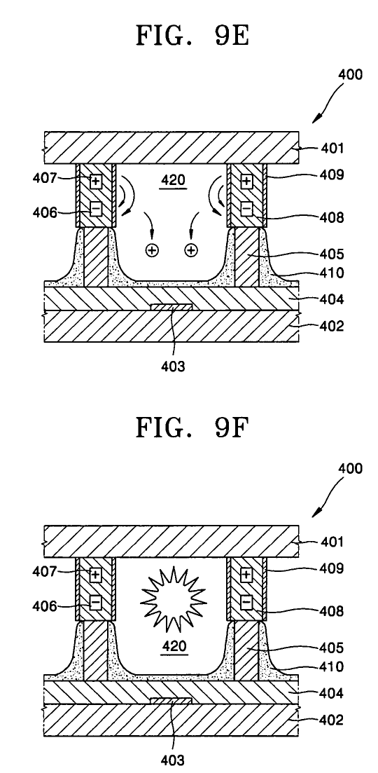

The Y electrode 406 may comprise two or more sub-electrodes 406a and 406b, and the X electrode 407 may also comprise two or more sub-electrodes 407a and 407b. Alternatively, the Y electrode 406 and the X electrode 407 may be formed as one electrode, as FIG. 9A shows.

As shown in FIG. 6, where the Y electrode 406 and the X electrode 407 include, respectively, two or more separate sub-electrodes (406a and 406b) and (407a and 407b), since a short distance exists between the X electrode's inner sub-electrode 407b and the Y electrode's inner sub-electrode 406a, a sustain-discharge between the X and Y electrodes may easily occur even with a low voltage. Also, since the Y electrode's outer sub-electrode 406b and the X electrode's outer sub-electrode 407a are farther apart, a discharge area widens. Consequently, since the cross-sectional area of the entire electrode decreases while providing the same discharge effect, power consumption may decrease relatively. If the X and Y electrodes have three or more sub-electrodes, a surface discharge may begin with innermost sub-electrodes and spread to the outermost sub-electrodes.

In FIG. 6, the Y electrodes 406 and the X electrodes 407 include two sub-electrodes. However, as noted above, the present invention is not limited to this case, and the number of sub-electrodes may be appropriately changed according to a design rule.

Short bars 406c and 407c may couple the Y electrodes' sub-electrodes 406a and 406b and the X electrodes' sub-electrodes 407a and 407b, respectively.

Coupling the Y electrodes' sub-electrodes 406a and 406b with the short bar 406c allows a sustain-discharge beginning from the inner sub-electrode 406a to easily spread to the outer sub-electrode 406b. Likewise, the X electrodes' structure will have the same effect.

FIG. 8 is a cross-sectional view, cut parallel to the front substrate 401, of the sub-electrode 407a of the X electrode 407. As FIG. 8 shows, the sub-electrode 407a may surround light-emitting cells 420, and it may be arranged in the same direction as the light-emitting cells 420, for example, in a horizontal direction. According to an exemplary embodiment of the present invention, the other sub-electrodes 406a, 406b, and 407b may also have the same cross-sectional structure as the sub-electrode 407a. Further, the same cross-sectional structure may also be used when the Y electrodes 406 and the X electrodes 407 are formed as one electrode without sub-electrodes.

Under the panel structure according to exemplary embodiments of the present invention, because the Y and X electrodes are formed inside the upper partition walls 408, light is diffused on the front substrate 401 through all regions W3, excluding the widths W4 of the partition walls, without structural interference from electrodes. Accordingly, the opening ratio may significantly increase as compared with the conventional 3-electrode surface discharge panel structure. Under the panel structure according to exemplary embodiments of the present invention, since light does not have to travel through electrodes, a dielectric layer, a protection layer, etc., transmittance may be significantly improved.

Hereinafter, a discharge process of the display panel, according to an exemplary embodiment of present invention, will be described in detail with reference to FIG. 7.

First, during an address period, applying a predetermined address voltage between predetermined address electrodes 403 and predetermined Y electrodes 406 selects a light-emitting cell 420 to emit light and accumulates wall charges on the selected cell's Y electrodes. During a sustain period following the address period, a sustain pulse is alternately applied to corresponding X electrodes 407 and Y electrodes 406, so that the wall charges move between the X and Y electrodes. The moving wall charges collide with discharge gas particles in the light-emitting cell 420, thereby generating plasma. Referring to FIG. 7, a discharge may be generated, with a high probability, between the neighboring inner sub-electrodes 406a and 407b of the Y electrodes and X electrodes, respectively, in which a relatively strong electric field may be formed during an initial sustain period.

Referring to the cross-sectional view of FIG. 8, since the Y electrodes 406 and the X electrodes 407 may be respectively disposed in a lower position and in an upper position around the light-emitting cell 420, discharge efficiency may be remarkably improved as compared with the conventional 3-electrode surface discharge type panel structure. As the discharge progresses, an electric field formed between the neighboring portions of the Y and X electrodes is gradually and strongly confined, and the discharge may spread to the entire area of the light-emitting cell 420.

In the conventional 3-electrode surface discharge panel structure, a discharge generated only from the upper portion of each light-emitting cell 420 spreads to the cell's center portion. However, in the panel structure according to the exemplary embodiment of the present invention shown in FIG. 8, a discharge generated in a ring-like form from four lateral portions surrounding each light-emitting cell 420 may spread to the cell's center portion. Accordingly, the spread range of the discharge may greatly increase. Hence, an amount of visible light generated may also significantly increase. Also, since plasma may be concentrated at the center portion of each light-emitting cell 420, space charges can be efficiently used, which allows low-voltage driving, improves light-emitting efficiency, and accelerates a discharge response speed. Also, since the plasma is concentrated at the center portion of each light-emitting cell 420, and the electric field caused by the Y and X electrodes forms near the plasma, charges may also be concentrated at the cell's center portion, thereby ultimately preventing ion-sputtering of the phosphor layers 410.

In the display panel structure according to the present invention as shown in FIG. 6, FIG. 7 and FIG. 8, it is important that a discharge response speed may be very fast. This advantage is obtained because plasma concentrates at the center portion of each light-emitting cell 420, and metal electrodes may be used instead of transparent electrodes.

Accordingly, in the panel structure according to exemplary embodiments of the present invention, it is possible to set a short sustain-discharge period. For example, the conventional 3-electrode surface discharge display panel may have about a 3 μs-5 μs sustain-discharge period. However, in the panel structure according to the present invention, sustain-discharging may be performed stably within a sustain-discharge period that takes less than 2 μs.

FIG. 9A, FIG. 9B, FIG. 9C, FIG. 9D, FIG. 9E and FIG. 9F are views for explaining the structure of a PDP according to an exemplary embodiment of the present invention and a sustain-discharge process performed by the PDP.

In a light-emitting cell structure shown in FIGS. 9A through 9F, unlike the light-emitting cell structure of FIG. 7, the Y electrode 406 and the X electrode 407 are formed as one electrode.

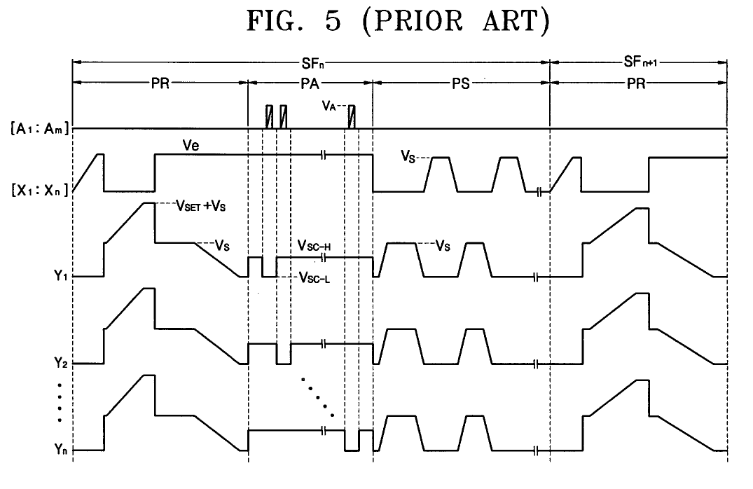

FIGS. 9A through 9F are views for explaining one period of alternating sustain-discharges performed between Y electrodes 406 and X electrodes 407 during a sustain discharge period PS, following an address period PA, when light-emitting cells are driven by the driving signals of FIG. 5.

First, referring to FIG. 9A, wall charges formed on Y electrodes 406 of a light-emitting cell 420 previously selected in the prior address period PA move to X electrodes 407. The direction the wall charges move depends on an electric field formed by a high-level voltage V_{S} applied to the Y electrodes 406 and a low-level voltage V_{G} applied to the X electrodes 407 during the sustain-discharge period PS. Initial discharge is generated, with a high probability, between the neighboring inner portions of the Y and X electrodes, in which a relatively strong electric field is formed.

Referring to FIG. 9B, as the discharge progresses, it spreads to the entire area of the electrodes 406 and 407 due to the spread of the electric field. As a result, the discharge spreads to the center portion of the light-emitting cell 420 from the cell's lateral portions.

Referring to FIG. 9C, due to the spread of the discharge, plasma is formed by the collision between electrons and discharge gas particles, and phosphors in phosphor layers 410 are excited by ultraviolet rays caused by the plasma, thus generating visible light.

As the discharge progresses, wall charges move. Due to the wall charge movement, if a potential difference between the Y and X electrodes drops below a discharge start voltage, the discharge terminates.

FIGS. 9D through 9F are views for explaining when a sustain-discharge is performed by applying voltages opposite to that described above with reference to FIGS. 9A through 9C.

The discharge shown in FIGS. 9D and 9E differs from that shown in FIGS. 9A and 9B, in that a portion of positive ions may sputter and damage the phosphor layers 410 during discharging. Although the panel structure according to exemplary embodiments of the present invention may prevent ion-sputtering, a portion of positive ions may still sputter the phosphor layers 410 due to the electric field's downward influence.

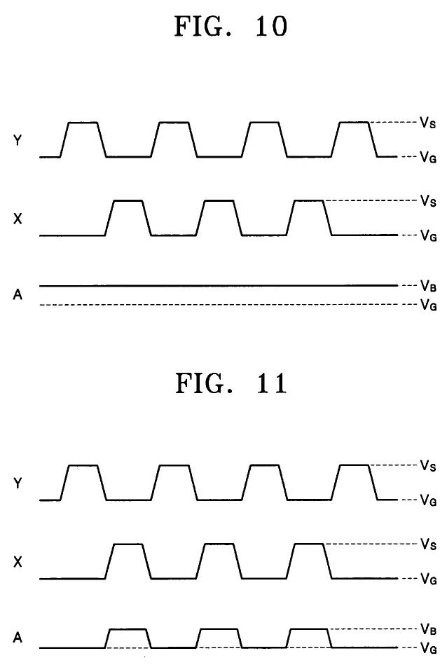

FIG. 10 is a timing diagram of a sustain-discharge driving signal according to an exemplary embodiment of the present invention.

Referring to FIG. 10, a predetermined bias voltage V_{B} may be applied to address electrodes A for a predetermined time while alternating sustain-discharges occur between the Y and X electrodes. The bias voltage V_{B} provides an upward electric power to positive ions during alternate sustain-discharges between the Y and X electrodes in a sustain-discharge period PS. Accordingly, positive ions may be prevented from sputtering the phosphor layers while the discharge spreads from the upper X electrodes to the lower Y electrodes.

FIG. 11 is a timing diagram of a sustain-discharge driving signal according to an exemplary embodiment of the present invention.

Referring to FIG. 11, a pulse of a predetermined bias voltage V_{B}, with the same period and phase as a sustain pulse applied to the X electrodes, may be applied to the address electrodes A in synchronization with the sustain pulse, during at least a portion of the alternating sustain-discharges between the Y and X electrodes. Here, a high-level interval of the bias voltage V_{B} pulse may be longer than a high-level interval of the sustain pulse V_{S}. Also, the bias voltage V_{B} may be equal to or less than the high-level voltage V_{S} of the sustain pulse. Otherwise, disturbance may occur while the discharge spreads from the X electrodes to the Y electrodes.

By using the driving signals described above, it may be possible to prevent positive ions from sputtering the phosphor layers. This sputtering may be more serious when applying an electric field downward, i.e., toward the phosphor layers, as shown in FIGS. 9D and 9E. Accordingly, applying a pulse of a predetermined bias voltage V_{B} to the address electrodes A when applying a sustain pulse to the X electrodes, as shown in FIG. 11, may reduce the sputtering of the positive ions to the phosphor layers.

FIG. 12 is a view for explaining sustain-discharging of a light-emitting cell 420 by the sustain-discharge signals of FIG. 10. Referring to FIG. 12, by applying a predetermined bias voltage V_{B} to address electrodes A during the sustain-discharge period, an electric field (depicted by bi-directional arrows) formed near the Y and X electrodes may be pushed and distorted towards the upper portion of the light-emitting cell 420. Consequently, it is possible to prevent positive ions from sputtering the phosphor layers during the sustain-discharge period.

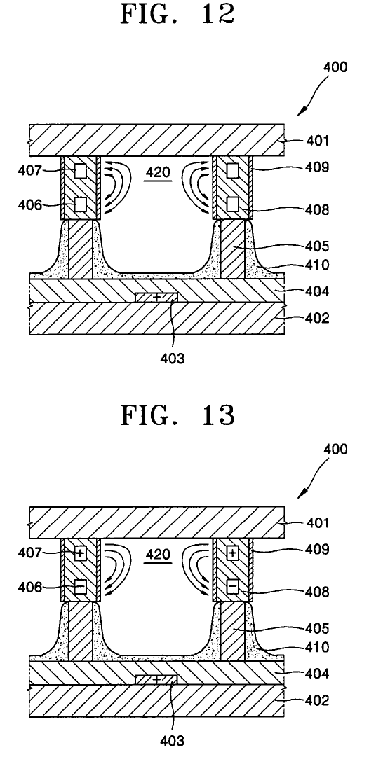

FIG. 13 is a view for explaining sustain-discharging of a light-emitting cell 420 by the sustain-discharge signals of FIG. 11. During a sustain-discharge period, a pulse of a predetermined bias voltage V_{B} may be applied to address electrodes A in synchronization with a pulse applied to the X electrodes. By using these driving signals, it is possible to prevent positive ions from sputtering the phosphor layers.

As described above, according to exemplary embodiments of the present invention, the following effects may be obtained.

In the PDP according to the present invention, visible light may be diffused to a front substrate through all regions excluding the widths of partition walls, without structural interference from electrodes. Accordingly, the opening ratio may increase as compared with the conventional 3-electrode surface discharge panel. Further, since light does not travel through electrodes, a dielectric layer, a protection layer, etc., transmittance may be significantly improved.

Also, in the PDP according to the present invention, a discharge generated in a ring-like form, from four lateral portions around each light-emitting cell, spreads to the center portion of the light-emitting cell. Accordingly, the spread range of discharge may increase, which increases an amount of visible light. Further, since plasma may be concentrated at the center portion of each light-emitting cell, space charges may be efficiently used, which allows for low-voltage driving, improved light-emitting efficiency, and accelerated discharge response speed.

Also, in the PDP according to the present invention, since plasma concentrates at the center portion of each light-emitting cell, ion-sputtering may be prevented. In particular, applying a predetermined bias voltage to address electrodes during a sustain-discharge period may prevent positive ions from sputtering the phosphor layers.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a transparent front substrate;
a rear substrate disposed parallel to the front substrate;
upper partition walls disposed between the front substrate and the rear substrate and demarcating light-emitting cells in a lattice pattern, wherein the light emitting cells are arranged in a first direction;
an upper electrode and a lower electrode disposed in the upper partition walls around the light-emitting cells and extending in the first direction; lower partition walls disposed between the upper partition walls and the rear substrate; and
an address electrode extending in a second direction intersecting the upper electrode and the lower electrode.

2. The PDP of claim 1, wherein:
light-emitting cells are selected by an address discharge between the address electrode and the lower electrode,
a sustain pulse is alternately applied to the upper electrode and the lower electrode to perform a sustain-discharge, and
a predetermined bias voltage is applied to the address electrode for a predetermined time while the sustain-discharge is performed.

3. The PDP of claim 2, wherein a pulse of a predetermined bias voltage, with a same period and a same phase as the sustain pulse applied to the upper electrode, is applied to the address electrode for a predetermined time while the sustain-discharge is performed.

4. The PDP of claim 3, wherein a high-level interval of the pulse of the predetermined bias voltage is longer than a high-level interval of the sustain pulse applied to the upper electrode.

5. The PDP of claim 2, wherein the predetermined bias voltage is equal to or less than a high-level voltage of the sustain pulse applied to the upper electrode

6. The PDP of claim 1, further comprising:
a protection film;
a phosphor layer; and
a dielectric layer,
wherein lateral portions of the upper partition walls are covered the protection film, the address electrode is disposed between the rear substrate and the phosphor layer, and the dielectric layer is disposed between the address electrode and the phosphor layer.

7. The PDP of claim 1, wherein the upper partition walls and the lower partition walls are integrally formed.

8. A light emitting cell of a display panel, comprising:
a first substrate and a second substrate;
a partition wall between the first substrate and the second substrate and defining a discharge area of the light emitting cell; and
a first electrode and a second electrode in the partition wall.

9. The light emitting cell of claim 8, wherein the first electrode and the second electrode surround the discharge area.

10. The light emitting cell of claim 9, further comprising:
an address electrode formed on the first substrate;
a dielectric layer covering the address electrode;
a phosphor layer; and
a protection layer,
wherein the partition wall comprises an upper partition wall formed on the second substrate and a lower partition wall formed on the dielectric layer,
wherein the phosphor layer is formed on the dielectric layer and on sides of the lower partition wall, and
wherein the protection layer is formed on sides of the upper partition wall.

11. The light emitting cell of claim 10, wherein the first electrode and the second electrode are formed in the upper partition wall.

12. The light emitting cell of claim 8, wherein the first electrode and the second electrode are metal electrodes.

13. The light emitting cell of claim 8,
wherein the first electrode and the second electrode comprise outer sub-electrodes and inner sub-electrodes, and
wherein the inner sub-electrodes of the first electrode and the second electrode are closer to each other than the outer sub-electrodes of the first electrode and the second electrode.

14. The light emitting cell of claim 13, wherein the inner sub-electrode and the outer sub-electrode of the first electrode and the second electrode are coupled to together with a short bar.

15. A plasma display panel comprising a plurality of light emitting cells of claim 8.

16. A plasma display apparatus, comprising:
a plasma display panel; and
an address electrode driver, a first electrode driver, and a second electrode driver coupled with the plasma display panel,
wherein the plasma display panel comprises:
a first substrate and a second substrate;
an upper partition wall formed on a surface of the second substrate facing the first substrate;
a lower partition wall formed on a surface of the first substrate facing the second substrate; and
a light emitting cell defined by the upper partition wall and the lower partition wall and comprising a first electrode and a second electrode in the upper partition wall, and an address electrode formed on the first substrate, and
wherein, during a sustain period:
the first electrode driver and the second electrode driver alternately apply a sustain pulse to the first electrode and the second electrode, respectively, and
the address electrode driver applies a voltage to the address electrode.

17. The plasma display apparatus of claim 16,
wherein the address electrode is closer to the second electrode than the first electrode, and
wherein, during an address period before the sustain period, an address discharge occurs between the address electrode and the second electrode.

18. The plasma display apparatus of claim 16, wherein during the sustain period, the address electrode driver applies a pulse to the address electrode having a same period and a same phase as the sustain pulse applied to the first electrode.

19. The plasma display apparatus of claim 18, wherein the pulse is applied to the address electrode for a longer time than the sustain pulse is applied to the first electrode.

20. A method for driving a plasma display panel including a first substrate, a second substrate, an upper partition wall formed on a surface of the second substrate facing the first substrate, a lower partition wall formed on a surface of the first substrate facing the second substrate, wherein the upper partition wall and the lower partition wall define a light emitting cell, and the light emitting cell comprises a first electrode and a second electrode in the upper partition wall, and an address electrode formed on the first substrate, the method comprising:
during a sustain discharge period,
alternately applying a sustain pulse to the first electrode and the second electrode; and biasing the address electrode at a positive voltage.

21. The method of claim 21, wherein biasing the address electrode comprises applying a pulse to the address electrode having a same period and a same phase as the sustain pulse applied to the first electrode.

22. The plasma display apparatus of claim 16, wherein the voltage applied to the address electrode is equal to or less than a magnitude of the sustain pulse.
